(19) United States
(12) Patent Application Publication
(10) Pub. No.: US 2017/0349034 A1
(43) Pub. Date: Dec. 7, 2017

(54) PROTECTION DEVICE FOR A VEHICLE INTERIOR COMPARTMENT

(71) Applicant: BOS GMBH & CO. KG, Ostfildern (DE)

(72) Inventors: Herbert WALTER, Ebersbach (DE); Huan TRAN, Ostfildern (DE); Matthias MAIER, Esslingen (DE); Gerald LINGEMANN, Kernen i.R. (DE)

(21) Appl. No.: 15/535,746

(22) PCT Filed: Nov. 11, 2015
(86) PCT No.: PCT/EP2015/076293

§ 371 Date: Jun. 14, 2017

(30) Foreign Application Priority Data
Dec. 15, 2014 (DE) 10 2014 225 902.9

(51) Int. Cl. B60J 1/20

(52) U.S. Cl. CPC B60J 1/208; B60J 1/2055; B60J 1/2025; B60J 1/2052

(57) ABSTRACT

Protection device for a vehicle interior compartment including a flexible planar structure held on a roller blind shaft windable and unwindable between a pulled-out protective position and a compactly stored rest position. The planar structure is connected to a dimensionally stable pull-out profile on a face end region that is in front in the pull-out direction, which profile is guided for longitudinal displacement on each of its opposite sides in a respective guiding structure disposed fixed to the vehicle in the ready-for-use condition. At least one supporting structure is provided for rotatable bearing of the roller blind shaft, wherein the lateral guiding structures are connected to the supporting structure and are pivotably arranged on the supporting structure for an assembly position. Securing elements for releasable fixation of the guiding structures in their assembly position, pivoted towards the supporting structure, are provided on the supporting structure.

The invention relates to a protection device for a vehicle interior compartment, comprising a flexible planar structure which is held on a roller blind shaft to be windable and unwindable between a pulled-out protective position and a compactly stored rest position, wherein the planar structure is connected to a dimensionally stable pull-out profile on a face end region that is in front in the pull-out direction, which profile is guided for longitudinal displacement on each of its opposite sides in a respective guiding structure disposed fixed to the vehicle in the ready-for-use condition, and comprising at least one supporting structure for rotatable bearing of the roller blind shaft, wherein the lateral guiding structures are connected to the supporting structure and are pivotably arranged on the supporting structure for an assembly position.

Such a protection device is disclosed in EP 1 215 063 A1. The known protection device is intended as a shading device for a rear window of a passenger vehicle. The shading device includes a flexible fabric which is held on a roller blind shaft for winding up and off. The roller blind shaft is rotatably mounted below a rear shelf. A passage slot is provided in the rear shelf, through which the fabric passes in order to allow its displacement along the rear window between a rest position and a pulled-out protective position. For displacing the fabric, the fabric is provided with a dimensionally stable pull-out profile on a face end region that is in front in the pull-out direction, which profile is guided on each of its opposite face ends in vehicle-fixable guiding rails for lengthwise displacement. In the region of the roller blind shaft the guiding rails are each connected to a respective supporting structure part which is designed as a bearing mounting for bearing the roller blind shaft. The guiding rails are connected to the supporting structure parts via a pivot joint, in order to allow pivoting in of the guiding rails for a pre-assembly position.

An object of the invention is to provide a protection device of the type mentioned in the introduction, which allows good handling of the protection device prior to and during an assembly of the protection device in a vehicle interior compartment.

This object is achieved in that securing elements for releasable fixation of the guiding structures in their assembly positions, pivoted towards the supporting structure, are provided on the supporting structure. The securing elements on the supporting structure are used to secure the guiding structures in the position pivoted in towards the supporting structure. The supporting structure is preferably embodied in a cartridge housing, wherein the roller blind shaft is rotatably mounted. Thus, the supporting structure together with the pivoted-in lateral guiding structures can be easily handled as a compact structural unit for storing, transportation and assembling in the vehicle interior, owing to the securing of the guiding structures by means of the securing elements.

The object of the invention is also achieved in that the guiding structure comprises a functional profile, along which profile a flexible pulling means for longitudinal displacement of the pull-out profile is installed, which remains on the functional profile in an upwardly deployed operational position and in the pivoted-in assembly position of the guiding structure. Thereby, the flexible pulling means can be pre-assembled on the guiding structure in advance and remain in said pre-assembled position even during the transportation, storage or assembly condition of the protection device. Preferably, a cable pull is provided as a flexible pulling means, wherein advantageously, in each of the two lateral guiding structures, each comprising a respective functional profile, a corresponding cable pull is installed.

In an embodiment of the invention, for pivoting the functional profiles, a corresponding hinge arrangement is provided for each functional profile on opposite sides of the supporting structure, said hinge arrangements respectively provided with a pulling means deflection device for guiding and securing the pulling means in relation to the respective functional profile in the pivoted-in assembly position. Preferably, the pulling means deflection device is at least one integrally molded guide lug provided in the region of the hinge arrangement or in a guiding track for the pulling means. The pulling means deflection device ensures that the pulling means does not skip out of a respective guiding track for the pulling means during pivoting in of the functional profile towards the assembly position or during pivoting out of the functional profile from the assembly position to the operational position.

In a further embodiment of the invention, the functional profiles are made of synthetic material and correspondingly disposed on the supporting structure over a tolerance compensation range. Advantageously, the tolerance compensation range is designed as a flexure bearing and integrally molded to the functional profile or the supporting structure. These embodiments are particularly advantageous if the supporting structure is also made of synthetic material. Advantageously, the supporting structure is constituted by casing arrangements disposed opposite in relation to the roller blind shaft, which casing arrangements accommodate the roller blind shaft rotatably between them.

Further advantages and features of the invention will become apparent from the claims and from the description below of a preferred exemplary embodiment of the invention which is illustrated with reference to the drawings.

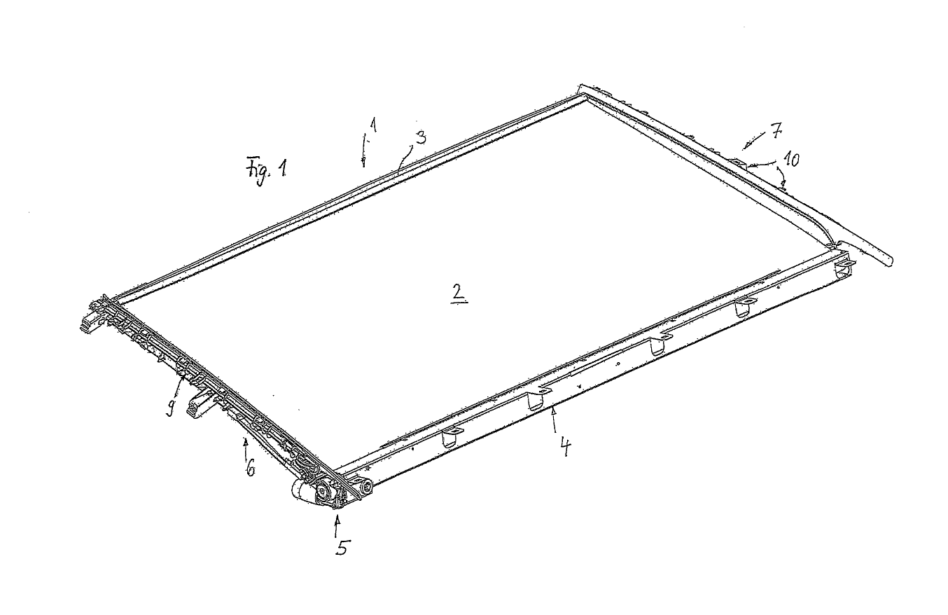

FIG. 1 shows a perspective illustration of an embodiment of a protection device according to the invention in the form of a shading device for a rear window of a passenger vehicle;

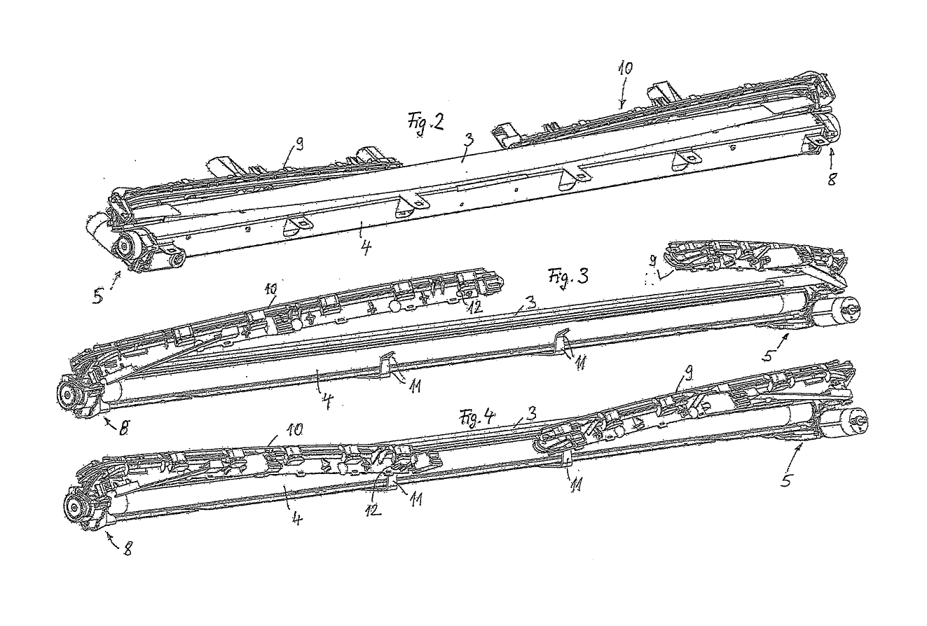

FIG. 2 shows the shading device according to FIG. 1 in an assembly position with lateral guiding structures pivoted in;

FIG. 3 shows the shading device according to FIG. 2 in an intermediate position of the lateral guiding structures shortly before reaching the pivoted-in assembly position;

FIG. 4 shows the shading device according to FIG. 3 with the guiding structures pivoted-in in the assembly position;

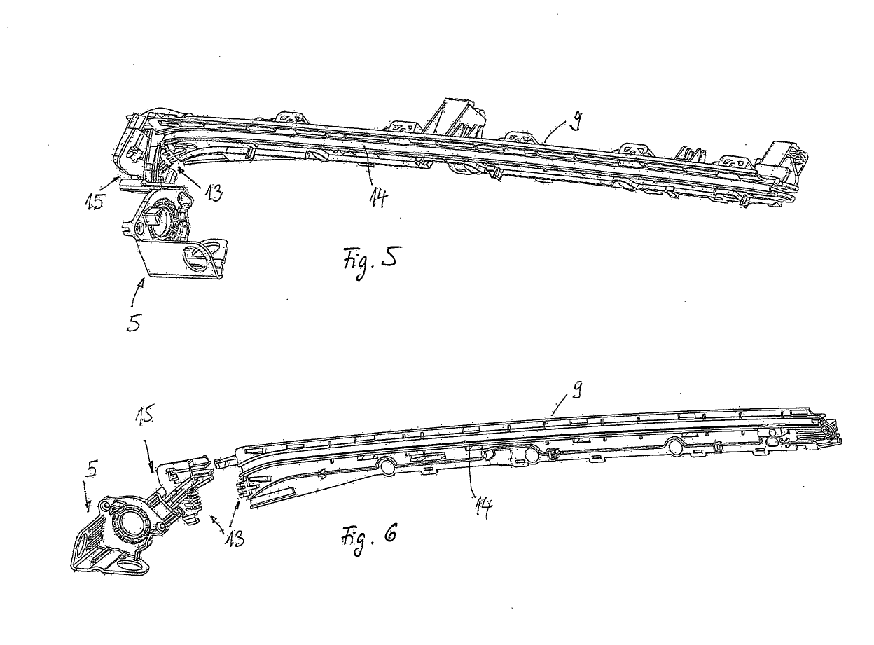

FIG. 5 shows a lateral casing arrangement of the shading device according to FIGS. 1 to 4 with molded-on lateral guiding structure;

FIG. 6 shows the casing arrangement with the guiding structure according to FIG. 5 in an exploded view;

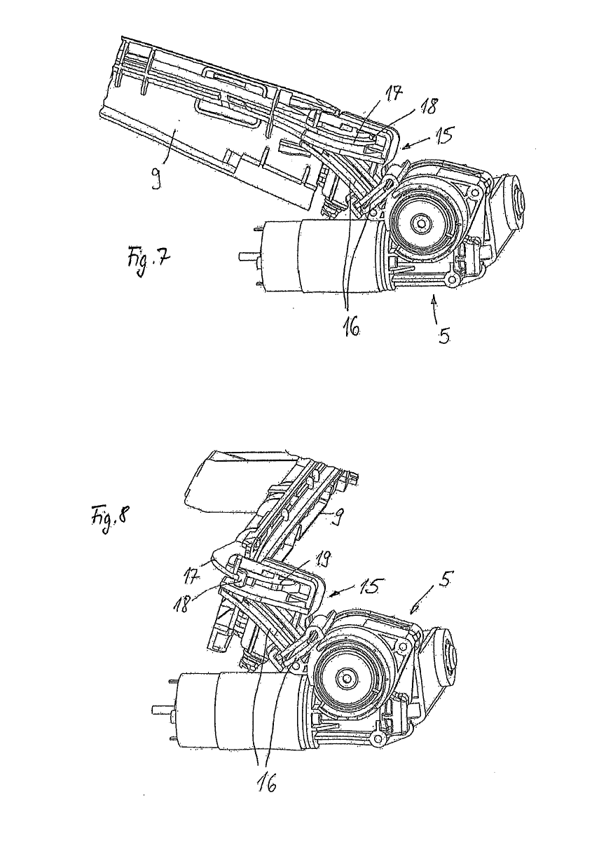

FIG. 7 shows a partial section of the shading device in the region of a driving side in the assembled final position of the guiding structure;

FIG. 8 shows the illustration according to FIG. 7 in the pivoted-in condition of the guiding structure;

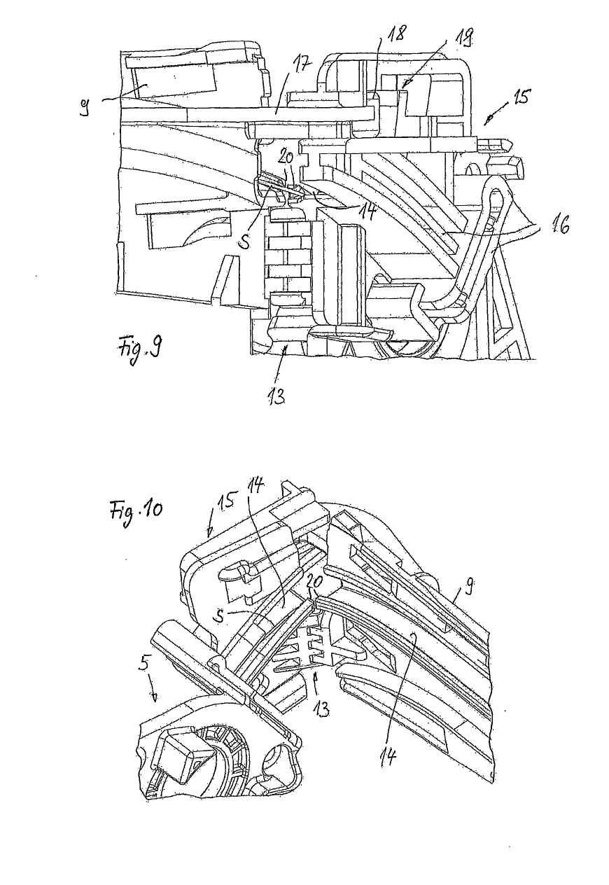

FIG. 9 shows an enlarged view of a section of the lateral guiding structure in the region of a hinge arrangement; and

FIG. 10 shows the section according to FIG. 9 in a reduced representation and different perspective view.

A protection device in the form of a shading device 1 according to FIG. 1 is intended for employment in a passenger vehicle. The shading device 1 is used to shade a rear window of the passenger vehicle. For shading is provided a flexible planar structure 2 in the form of a textile knitted or woven fabric which is held on a roller blind shaft to be windable and unwindable. The roller blind shaft is rotatably mounted in a supporting structure which comprises a cartridge-type accommodation profile 4. The accommodation profile 4 is closed on each of the opposite face end regions thereof by a respective casing arrangement 5, 8. The two casing arrangements 5, 8 are also used as a bearing on the face end side for the roller blind shaft extending within the accommodation profile 4. The roller blind shaft is designed without a winding spring and is driven by an electric motor which is fixed in the region of the casing arrangement 5. The electric motor, together with corresponding torque transmission means is associated with the casing arrangement 5 on the drive side. The torque transmission means transmit torques and speeds of the electric motor to the roller blind shaft. The casing arrangement 8 on the opposite face end of the roller blind shaft has torque transmission means of identical design, with the difference that a distinct electric motor is not provided there. Rather, the casing arrangement 8 is the output-sided casing arrangement. In addition to the roller blind shaft, the electric motor also drives two cable pulls which are installed on opposite sides of the planar structure 2 in lateral guiding structures 6, 7. In that context, the roller blind shaft in connection with the torque transmission means is used to transmit the driving forces of the electric motor also to the output-sided cable pull. Both the cable pulls comprise a respective cable drum, which drums are rotatably mounted coaxially to the rotational axis of the roller blind shaft in the opposite casing arrangements 5, 8. Each cable drum is connected to the torque transmission means using a cable length compensation unit in the form of a torsion spring for torque absorption.

The lateral guiding structures 6, 7 are used to displace opposite face end regions of a dimensionally stable pull-out profile 3 in parallel, which pull-out profile is fixed to the face end region of the planar structure 2 that is in front in the pull-out direction. Each guiding structure 6, 7 is configured in two parts composed of a functional profile 9, 10 and a lining cover not explained in more detail. The functional profiles 9, 10 as well as the lining covers are respectively produced in one piece made of thermoplastic synthetic material. The functional profiles 9, 10 of the opposite guiding structures 6, 7 are disposed, in the assembled functional condition of the shading device 1, fixed to the vehicle in a vehicle interior on opposite vehicle-body pillar structures. The lining covers are flush with corresponding lining parts of the respective vehicle-body pillar sections in the vehicle interior in the ready-for-use completely assembled functional condition. Each functional profile 9, 10 is connected to the respective casing arrangement 5, 8 via a respective hinge arrangement 13. Each functional profile 9, 10 has, on its inner side facing the planar structure 2, a longitudinally extending guiding groove 14, wherein a respective sliding body is guided for longitudinal displacement, which sliding body is fixed to a respective face end of the pull-out profile 3. One cable end of a respective cable S of the corresponding cable pull engages on the sliding body, while the other cable end is held on the respective cable drum in the region of the casing arrangement 5, 8. Thereby, the respective cable S is installed lengthwise of the functional profile—starting from the respective cable drum—up to a face end region of the functional profile, is there deflected over a sliding guide and, subsequently, returned to the respective sliding body on which said cable end engages. The electric motor drives both the roller blind shaft and the two cable drums, owing to the drive system configured in this manner, such that the electric motor causes both displacement of the pull-out profile 3 between a pulled-out protective position of the planar structure 2 and a wound-up rest position, and also rotation of the roller blind shaft. As a result, there is a closed drive system for displacement of the planar structure 2 between its rest position, wherein it is wound-up on the roller blind shaft within the accommodation profile 4, and its protective position, wherein it is spread out along the rear window in order to achieve shading of the rear window.

For fixing the respective functional profile 9 on the respective casing arrangement 5, 8, each casing arrangement is provided with an integrally molded projection 15, comprising elastically movable tolerance compensation ranges 16. Said tolerance compensation ranges 16 allow an adjustment of the functional profiles 9, 10 to the fixation regions of the corresponding vehicle-body pillar sections during assembly of the functional profiles 9, 10 within the vehicle interior. The tolerance compensation ranges constitute flexure bearings in the region of the projection 15, which allow elastic angular adjustment options for positioning the respective functional profile 9, 10 in different directions.

With reference to FIGS. 5 to 8, it is apparent that the respective functional profile 9, 10 is pivotably disposed on the projection 15 of the respective casing arrangement 5, 8 by means of a respective hinge arrangement 13. The hinge arrangement 13 includes integrally molded hinge joints on the projection 15 and on the functional profile 9, 10, respectively, which joints are mutually interlockable and interconnectable by means of a hinge pin (not illustrated). A guide arch 17 together with an end cam 18 on the functional profile 9, 10, and a complementary, arched guide 19 on the projection 15 limit pivot mobility of the functional profile 9, 10 in relation to the projection 15.

With reference to FIGS. 1 to 8, it is apparent that each functional profile 9, 10 in the ready-for-use completely assembled functional condition extends in continuation of the respective projection 15 from the respective casing arrangement 5, 8 transversely in relation to a rotational axis of the roller blind shaft obliquely upwards, so that the planar structure 2 is flanked by the two functional profiles 9, 10 at least largely in parallel. In an assembly position, however, the two functional profiles 9, 10 are pivoted towards the supporting structure part and, thus, towards the accommodation profile 4. Said assembly position is utile to allow handling of the shading device 1 during storage and transportation prior to installation into the passenger vehicle as a compact structural unit. In the pivoted-in assembly position the two functional profiles 9 and 10 are pivoted inwards approximately in parallel to the accommodation profile 4. On the accommodation profile 4 are provided securing means 11 in the form of securing lugs which plunge into corresponding recesses 12 on the respective functional profile 9, 10 and, thus, allow fixing to the accommodation profile 4.

The securing elements 11 are configured as sheet metal tabs fixedly connected to the accommodation profile 4, with the tips thereof serving as securing lugs. The securing lugs are plastically deformable so that the securing lugs, after passing through the recesses 12, can be bent over in order to achieve form-fitting securing of the functional profiles 9, 10 to the accommodation profile 4. Apart from that, the functional profiles 9, 10 remain connected to the respective casing arrangement 5, 8 in the region of the hinge arrangements 13.

Pivoting of the functional profiles 9, 10 to the pivoted-in assembly position is performed after completed pre-assembly of the drive system for the shading device. What is meant thereby is that even the cable pulls and their cables S are already installed along the functional profiles and connected to the sliding bodies of the pull-out profile 3. In the assembly position the sliding bodies are positioned in parking positions of the guiding grooves 14 in the region of the respective projection 15 of the respective casing arrangement 5, 8. Accordingly, the two cables S are almost completely pulled-off the respective cable drum and installed on the outer side along the respective functional profile 9, 10 and led back into the guiding groove 14 from above via a circular arc-shaped sliding guide up to the sliding body which is located in the parking position in the respective projection 15. During pivoting in of the functional profiles 9, 10 even the cable S in the respective guiding groove 14 is pivoted as well thereby. In order to prevent the cable S from skipping out of the guiding groove 14 in the region of the hinge arrangement 13, when the respective functional profile 9, 10 is pivoted inwards from the functional position to the assembly position, the guiding groove 14 of each functional profile 9 has deflection lugs 20 in the transitional region between the projection 15 and the functional profile 9, 10 in the vicinity of the respective hinge arrangement 13 (FIGS. 9 and 10) to retain the cable S in a form-fitting manner in the guiding groove 14. The deflections lugs 20 are integrally molded to an inner side edge of the guiding groove 14 and protrude inwards to a minor extent in relation to a bottom surface of the guiding groove 14, in order to cause form-fitting backing for the cable S which is deflected correspondingly at this location (FIGS. 9 and 10). Since the cable S during pivoting of the functional profiles 9, 10 is necessarily tensioned due to the cable length compensation unit in the form of a torsion spring or similar, the cable S is always abutting on the inner side of the inner walls of the corresponding deflection lugs 20 in the folded assembly position.

1. Protection device for a vehicle interior compartment, comprising a flexible planar structure which is held on a roller blind shaft to be windable and unwindable between a pulled-out protective position and a compactly stored rest position, wherein the planar structure is connected to a dimensionally stable pull-out profile on a face end region that is in front in the pull-out direction, which profile is guided for longitudinal displacement on each of its opposite sides in a respective guiding structure disposed fixed to the vehicle in the ready-for-use condition, and comprising at least one supporting structure for rotatable bearing of the roller blind shaft, wherein the lateral guiding structures are connected to the supporting structure and are pivotably arranged on the supporting structure for an assembly position, where securing elements for releasable fixation of the guiding structures in their assembly positions, pivoted towards the supporting structure, are provided on the supporting structure.

2. Protection device according to claim 1, wherein the guiding structure comprises a functional profile, along which a flexible pulling means for longitudinal displacement of the pull-out profile is installed, which remains on the functional profile in an upwardly deployed operational position and in the pivoted-in assembly position of the guiding structure.

3. Protection device according to claim 2, wherein for pivoting the functional profiles a respective hinge arrangement is provided for each functional profile on opposite sides of the supporting structure, which hinge arrangement is provided with a pulling means deflection device for guiding and securing the pulling means relative to the respective functional profile in the pivoted-in assembly position.

4. Protection device according to claim 2, wherein the functional profiles are made of synthetic material and are disposed respectively on the supporting structure over a tolerance compensation range.

5. Protection device according to claim 4, wherein the tolerance compensation range is designed as a flexure bearing and is integrally molded to the functional profile or the supporting structure.
